(19) United States
(12) Patent Application Publication
(10) Pub. No.: US 2017/0283289 A1
(43) Pub. Date: Oct. 5, 2017

(54) A BIOLOGICAL WASTE WATER PURIFICATION MODULE

(71) Applicant: Miranda Cevre Ve Su Aritma Tecknolojileri Enerji Ve Tabi Muhendisli Musavirlik Insaat Imalat Ve Tic, Yenimahalle, Ankara (TR)

(72) Inventor: Bulent HATAY, Beysukent, Ankara (TR)

(21) Appl. No.: 15/508,847

(22) PCT Filed: Apr. 10, 2015
(86) PCT No.: PCT/TR2015/000150

§ 371 Date: Mar. 3, 2017

(30) Foreign Application Priority Data
Nov. 3, 2014 (TR) 2014/12856
Jan. 19, 2015 (TR) 2015/00586

(51) Int. Cl. C02F 3/08

(52) U.S. Cl. CPC C02F 3/082

(57) ABSTRACT

A development improves values such as energy consumption, noise, etc., besides, increasing the efficiency of a purification module used during a purification of waste water. A patterned disc enables biological activity to be carried out in a larger area by way of a high surface area. Besides this, three guiding channels located on the disc, which pass through the centre and which are used to realize a renewal of a biofilm layer when the live biofilm layer needs to be renewed, are improved. Components that can prevent interruptions in tie rods that might occur, and breakages and a folding of a main return shaft, are developed.

### CROSS-REFERENCE TO RELATED APPLICATIONS

This application is a U.S. National Phase of PCT International Application No. PCT/TR2015/000150, filed on Apr. 10, 2015. That application claims priority to Turkish Patent Application No. 2014/12856, filed Nov. 3, 2014 and Turkish Patent Application No. 2015/00586, filed Jan. 19, 2015. The contents of the three aforementioned applications are herein incorporated by reference in their entirety.

### TECHNICAL FIELD

The invention is related to a waste water purification module comprising modular parts that improve the manufacturing, storage and delivery processes, and which accommodates the developments of technical aspects which improve the energy consumption, and values such as noise besides increasing the efficiency of the biological waste water purification module used during the purification of waste water.

### BACKGROUND ART

Waste water purification systems ensure the physical, chemical and biological decomposition of the pollutants that the water contains. The systems which are particularly biological in relation to such decomposition procedures require surface space and oxygen. For this reason, as the sizes are large, various additional systems are required in order to increase the oxygen amount inside the waste water.

One of the examples to such a system has been described in the Chinese patent application numbered CN103570126A. According to said patent application in order to biologically clean the sewage water inside the tank, the respiration of oxygen by the bacteria found in the water is tried performed.

Another example known within the state of the art is the utility model application numbered TR2014/12856 titled “Development of a Biological Waste Water Purification Module”. In this application, a biological waste water purification module with a drum having patterned discs, in order to perform high biological activity has been described. The figures of said module have been given in the present patent application and the parts that were present in the prior art have been shown according to said figures. As it can be seen in the figures and in the utility model application the body and the cover has been produced from a single piece and it takes up too much space during storage and delivery.

### BRIEF SUMMARY

The aim of the invention is to develop the patterned disc which enables the biological activity to be carried out in a larger area by means of the high surface area. Besides this, the invention aims to develop three guiding channels located on said disc, which pass through the centre and which are used to realize the renewal of the biofilm layer when said live biofilm layer needs to be renewed. The invention also aims to develop the components that can prevent the interruptions in the tie rods that could occur, and the breakages and folding of the main return shaft.

The aim of the invention aims to develop the specially designed pattern disc and the specially designed drum which has been produced from the same material as the waste water purification module body and the cover, which can be easily and quickly mounted and dismounted, and which are produced as panel moulds with screws, using fibreglass reinforced polyester material. The patterned disc high surface area enables the biological activity to be carried out in a larger area and with higher efficiency. Besides this the present invention additionally aims to develop the conical holes acting as water jets that are located on the drum, which are used to break up the slurry flocculation which could lead to odour as the waste water and air carried by the drum when the drum is being submerged under water are directed to the central section of the drum; and they accumulate therein without being in contact with oxygen.

The reason that the discs within the drum are formed of two pieces that are spaced apart is to ensure easier delivery of the water and air to the centre of the drum.

The invention aims to develop the three guiding channels located on the disc, which pass through the centre and which are used in order to renew the live biofilm layer when it is necessary to be renewed.

Moreover the invention aims to develop the components that shall prevent the interruptions in the tie rods that could occur, and the breakages and folding of the main return shaft.

### BRIEF DESCRIPTION OF THE DRAWINGS

FIG. 1—Is the blown up perspective view of the biological waste water purification module subject to the invention.

FIG. 2—Is the front view of the biological waste water purification module subject to the invention.

FIG. 3—Is the side view of the biological waste water module subject to the invention.

FIG. 4—Is the top view of the half horizontal disc of the biological waste water purification module subject to the invention.

FIG. 5—Is the front view of the half horizontal disc of the biological waste water purification module subject to the invention.

FIG. 6—Is the side view of the half horizontal disc of the biological waste water purification module subject to the invention.

FIG. 7—Is the front view of the half diagonal disc of the biological waste water purification module subject to the invention.

FIG. 8—Is the front view of the half diagonal disc of the biological waste water purification module subject to the invention.

FIG. 9—Is the side view of the half diagonal disc of the biological waste water purification module subject to the invention.

FIG. 10—Is the front view of the diagonal full disc established by combining the two half diagonal discs of the biological waste water purification module subject to the invention

FIG. 11—Is the detailed view of the biological waste water purification module shaft subject to the invention.

FIG. 12—Is the front view of the horizontal full disc that has been formed by combining the two half horizontal discs of the biological waste water purification module subject to the invention.

FIG. 13—Is the blown up perspective view of the biological waste water purification module having panels with screws subject to the invention.

FIG. 14—Is the front view of the biological waste water purification module having panels with screws subject to the invention.

FIG. 15—Is the side view of the biological waste water purification module having panels with screws, subject to the invention.

FIG. 16—Is the blown up perspective view of the biological waste water purification module body having panels with screws subject to the invention.

FIG. 17—Is the side view of the side panel of the body forming the body of the biological waste water purification module having panels with screws subject to the invention.

FIG. 18—Is the side view of the front panel of the body forming the body of the biological waste water purification module having panels with screws subject to the invention.

FIG. 19—Is the side view of the base of the body forming the body of the biological waste water purification module having panels with screws subject to the invention.

FIG. 20—Is the blown up perspective view of the cover of the biological waste water purification module having panels with screws subject to the invention.

FIG. 21—Is the side view of the side panel of the cover, forming the cover of the biological waste water purification module having panels with screws subject to the invention.

FIG. 22—Is the side panel of the cover logo panel forming the cover of the biological waste water purification module having panels with screws subject to the invention.

FIG. 23—Is the side view of the drum of the biological waste water purification module having panels with screws subject to the invention.

FIG. 24—Is the perspective view of the drum separator of the biological waste water purification module having panels with screws subject to the invention.

FIG. 25—Is the perspective view of the front/rear panel of the biological waste water purification module having panels with screws subject to the invention.

FIG. 26—Is the perspective view of the drum-shaft connection piece of the biological waste water purification module having panels with screws subject to the invention.

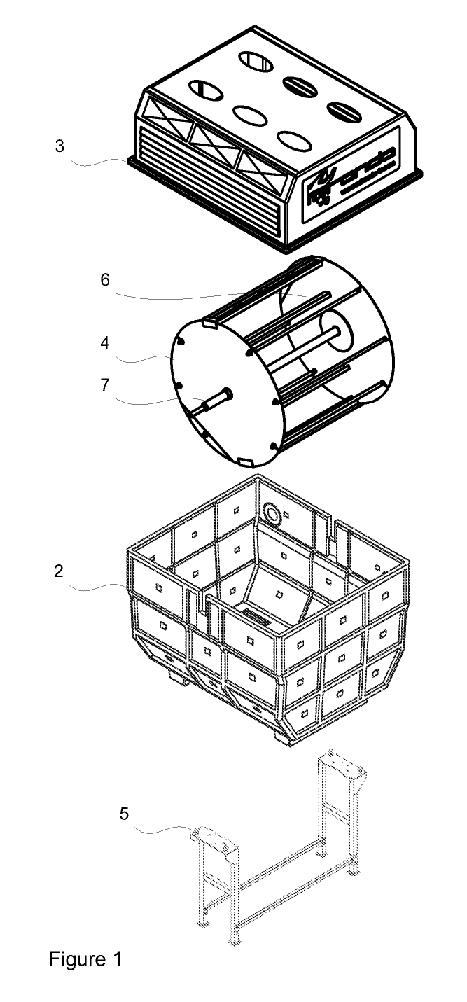

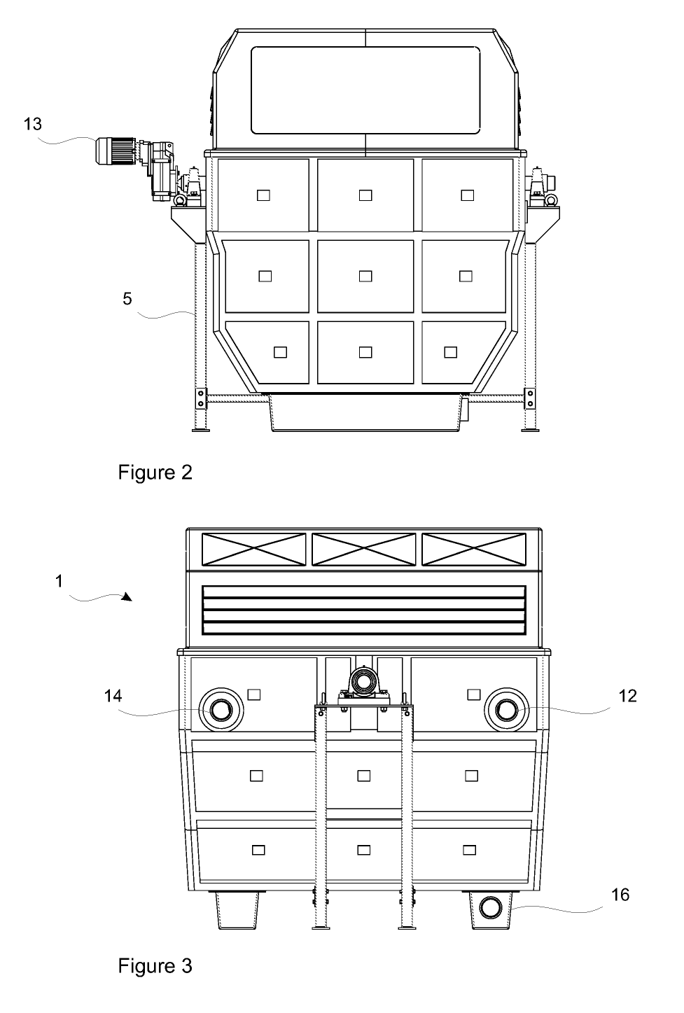

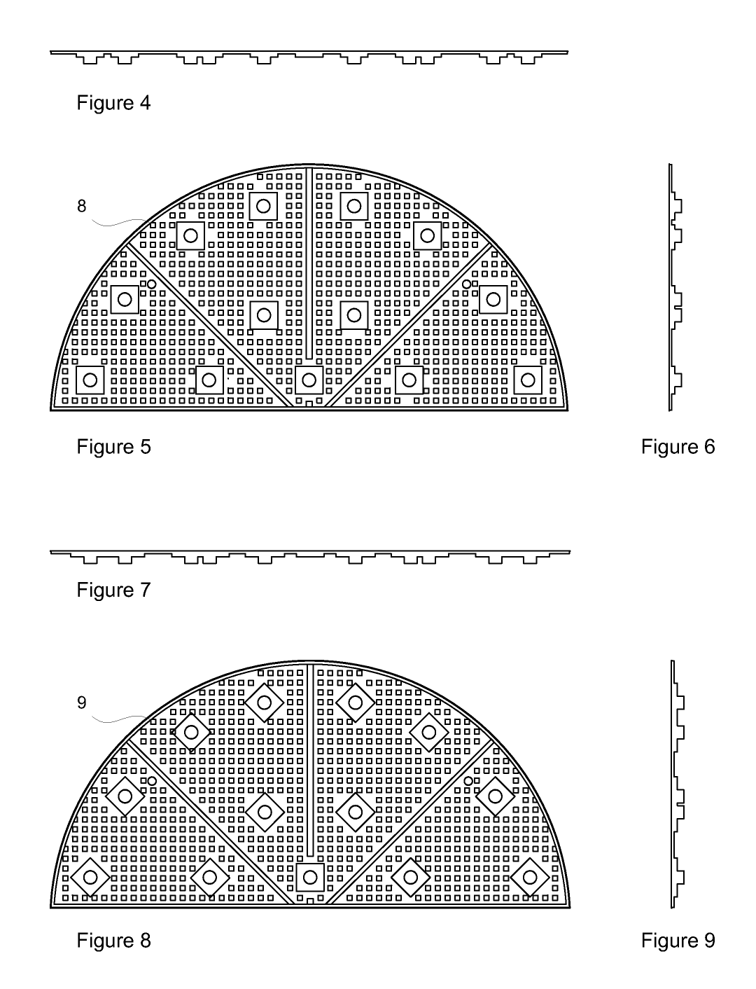

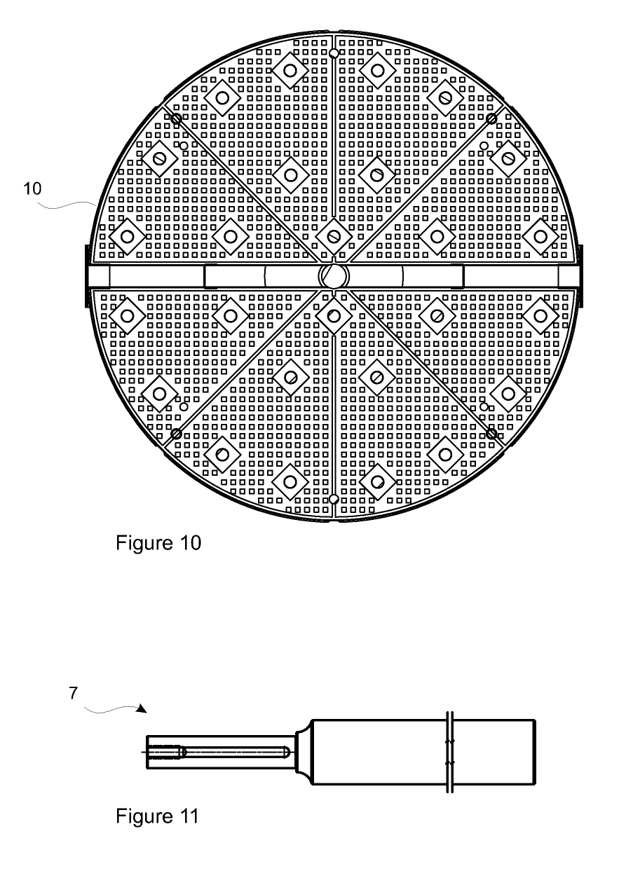

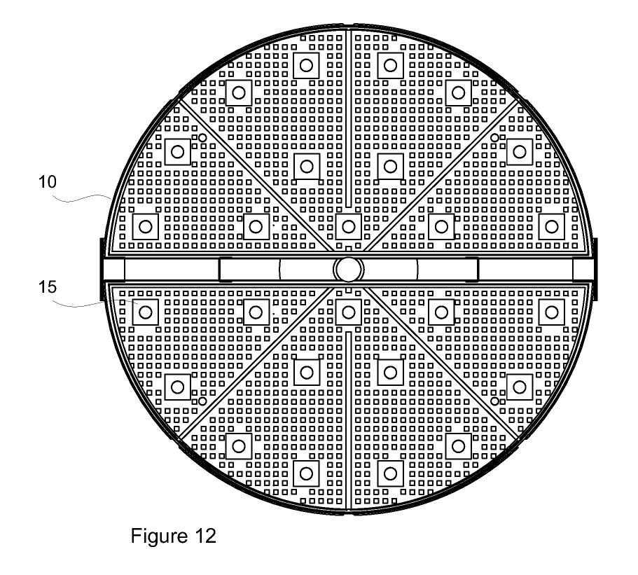

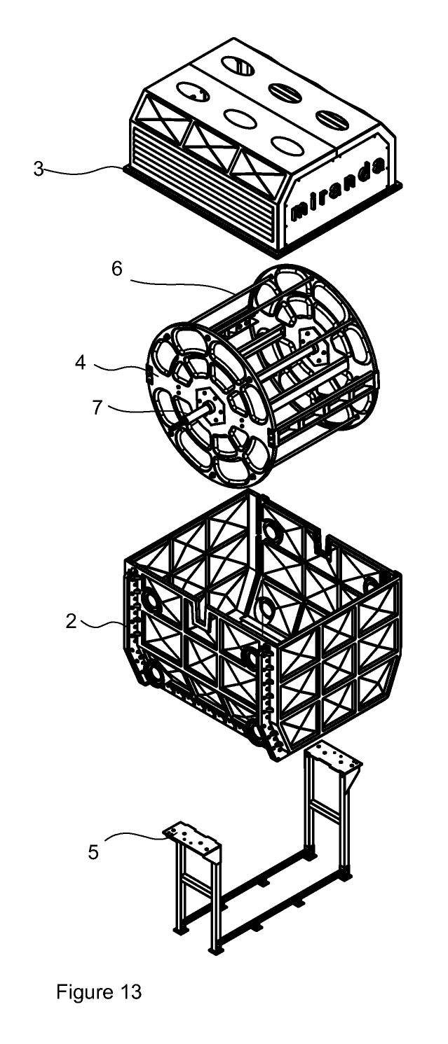

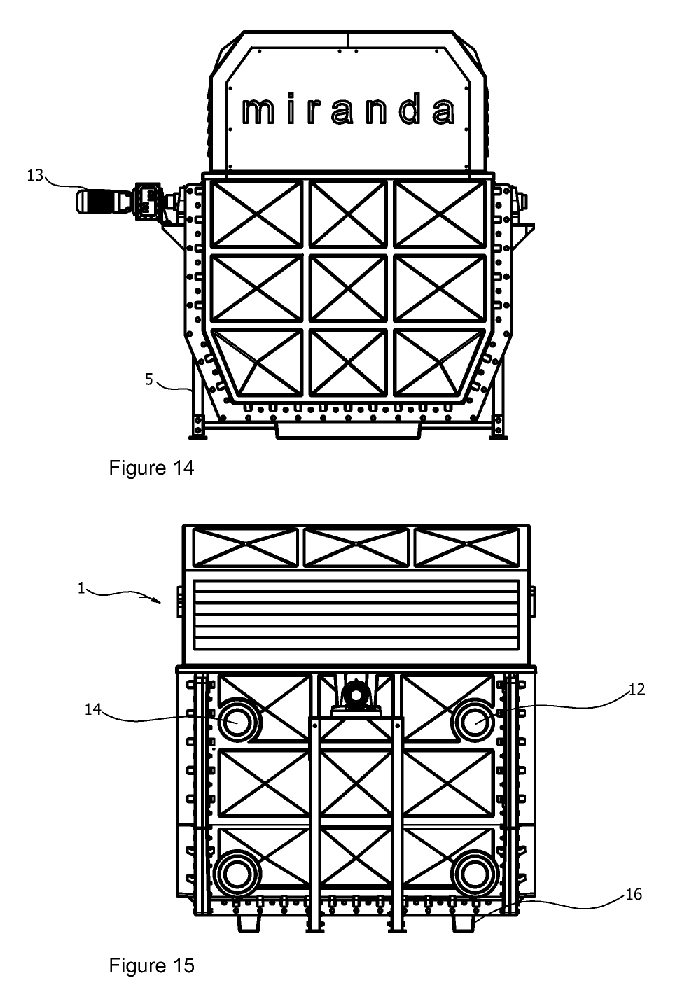

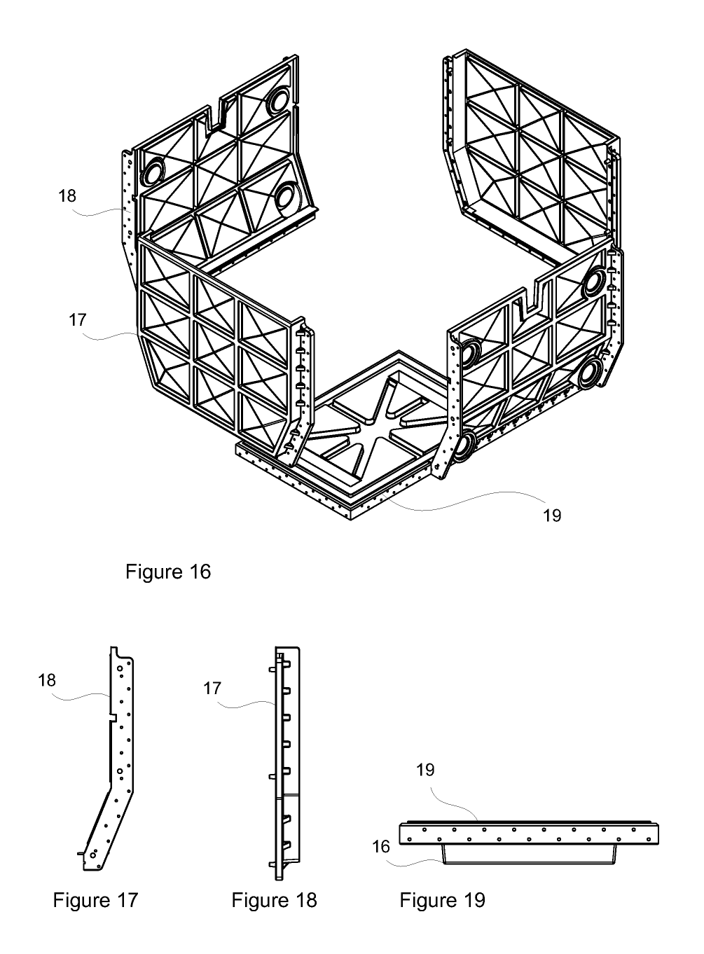

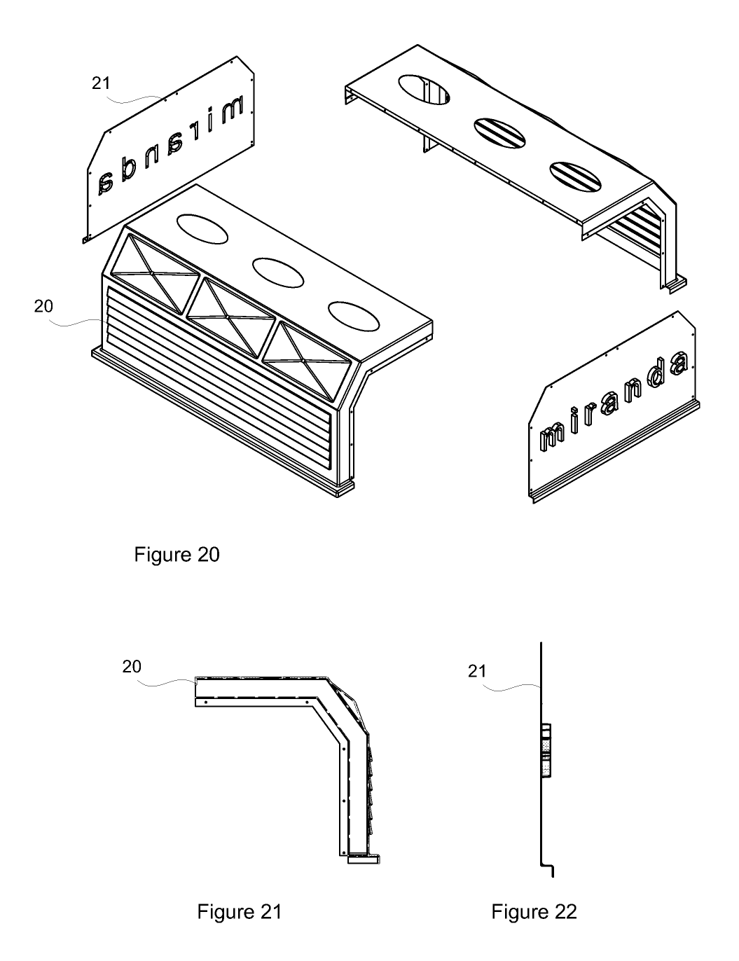

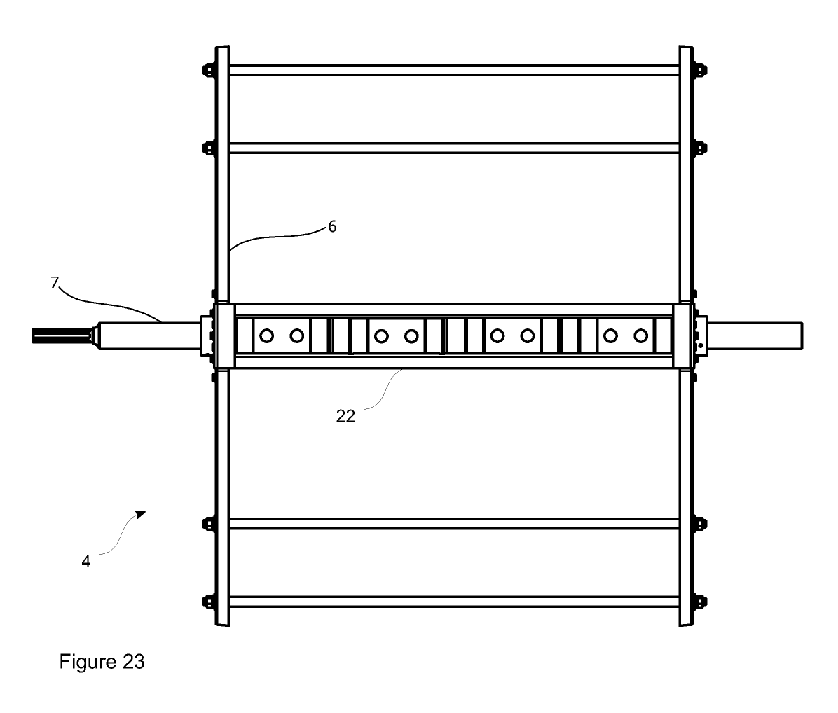

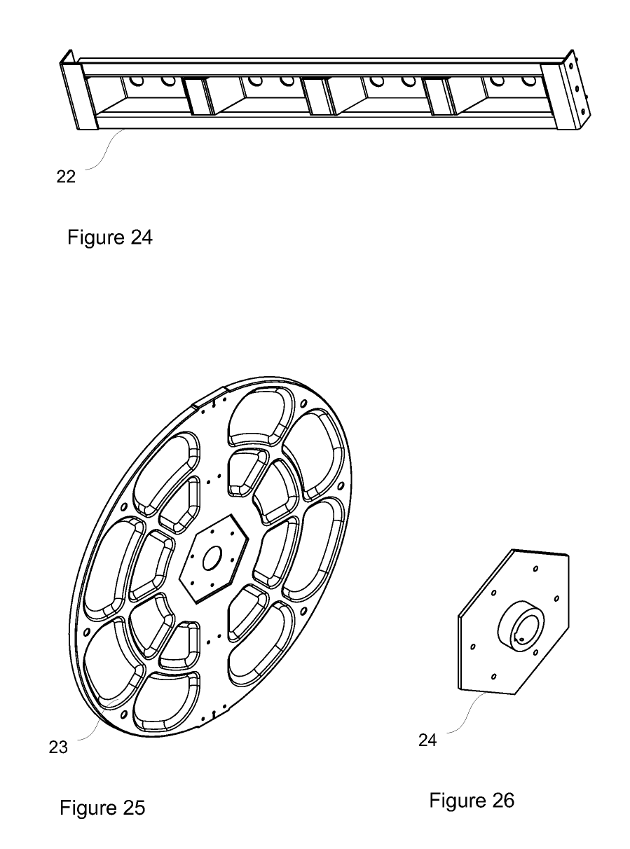

Each of the parts that form the invention has been numbered in the figures wherein the references of each number have been listed below.
1. Purification module
2. Body
3. Roof
4. Drum
5. Leg
6. Tie rod
7. Shaft
8. Horizontal connection point half disc
9. Diagonal connection point half disc
10. Diagonal connection point full disc
11. Horizontal connection point full disc
12. Clean water outlet
13. Motor
14. Waste water inlet
15. Conical protrusion
16. Fibreglass leg
17. Body front/rear panel
18. Body side panel
19. Body base
20. Cover side panel
21. Cover logo panel
22. Drum separator
23. Drum front/rear panel
24. Drum-shaft connection piece

### DETAILED DESCRIPTION OF EMBODIMENTS

The biological waste water purification module (1) subject to the invention basically comprises, a body (2) which receives the waste water and wherein the purification process is carried out; a cover (3) which covers all of the components; horizontal half discs (8) and diagonal half discs (9) where the biological materials shall be located on and whose whole surface shall be used for the purification process; a drum (4) which carries the horizontal half discs (8) and the diagonal half disks (9) and a motor (13) which enables the rotation of the drum (4). While the motor (13) rotates the drum (4), it also rotates all the horizontal half discs (8) and the diagonal half discs (9). By this means the bacteria which decompose via oxygen and which ensure the purification of waste water are activated.

In order for the bacteria to spend half their time during activation inside the waste water and the remaining other half outside of the water; the body (2) carrying the drum, has been filled with waste water at a close distance to the axis of the shaft (7) which is connected to the motor (13) which enables the rotation of the drum (4). During each cycle the whole drum (4) and as a result the horizontal half discs (8) and the diagonal half discs (9) shall be completely submerged into the water once. The speed of the motor (13) can be adjusted depending on the type and amount of the bacteria located on the discs.

The horizontal half discs (8) and the diagonal half discs (9) merge with their own pairs and form the diagonal full disc (10) and the horizontal full disc (11). The half pieces which form each disc, are produced from polyethylene or a similar material and as a result the productions of discs which are durable against low/high pH environments have been provided. Each of the discs have been shaped and their surface areas have been increased in order to be used during the separation process with bacteria as a large surface area is crucial during said separation process. In order to reach this aim, heat has been applied inside the thermoform machine to the PE plate and said plate has been shaped under vacuum within aluminium moulds. At least a 14% increase in the surface area has been provided by means of the shape given. Moreover, besides the bacteria loading capacity obtained by increasing the surface area, the strengths of the discs have also been improved.

The horizontal half disks (8) and the diagonal half disks (9) can be produced in various sizes and thicknesses depending on the dimensions of the body (2). Moreover in order to decrease the weights of the parts and to ensure easy replacement, each disc has actually been formed as two half discs.

In order to retain the advantage of the large surface area obtained by forming the discs, the loss of area (bridging) is prevented as a result of the overlapping of the diagonal full discs (10) and horizontal full discs (11) which have been sequentially aligned on the drum (4). In order to reach this aim, the advantage of the preformation of the sequential alignment of the diagonal full disc (10) and the horizontal full disc (11) one after the other, has been used. The pattern difference obtained by means of the difference of the horizontal or diagonal positions relative to the floor of the conical protrusions which pass through the tie rod (6) on each part, shall prevent the two parts from fitting onto each other.

The number of the diagonal and horizontal conic protrusions (15) on each horizontal half disc (8) and the diagonal half disc (9) is thirteen. The 26 tie rods (6) on a drum (4) enable the coupling of all these parts. The weight of the drum (4) increases due to the discs and the bacteria mass carried on said discs. In order to ensure that the weight of all these components is not carried by the body (2), the weight is transferred to the leg (5) by means of the shaft (7).

After the live bacteria layer on the discs complete their mission and they die, an important aspect of the invention in terms of usage is that the discs need to be cleaned and a new biofilm layer needs to be established. In order to reach this aim, the 3 channels which pass through the centre of the discs shall be used to remove and eliminate the dead biofilm layer.

The waste water inlet (14) located on the body (2), enables the intake of waste water and following the purification of the water biologically, the clean water is discharged out of the body via the clean water outlet (12) located again on the body (2).

The body (2) has been formed of at least a 5 layered fibre material having an angular form with an embossed surface in order to carry the weight of the water thereon. In order for the body (2) to retain its shape, and in order for it to be able to be carried without being shaken, even if it is full, the inner part has been fitted with a box profile framework coated with fibreglass and polyester.

In order for the weight of the drum (4) not to be loaded on the body (2) as mentioned above, the leg (5) carries the drum (4) directly by means of the shaft (7). Two fibreglass legs (16) are present at the base section of the body (2) which are in contact with the ground. These fibreglass legs (16) both carry the weight of the body and store the waste slurry inside the inner volume that they create.

The cover (3) has also been produced from fibreglass material similar to the body (2) and it also accommodates the holes which allow the inlet and outlet of air. By means of the invention rotating the discs using a low speed motor for the ventilation of especially bacteria it has been aimed for both the noise level to be reduced and the energy consumption value to be decreased.

The detailed description of the embodiment of the invention comprising a body (2) and a cover (3), which has been produced as panels having screws.

The biological waste water purification module (1) subject to the invention basically comprises a body (2) which can be stored and delivered at a mounted or dismounted state and which has been produced as a panel having screws by means of its design, which can receive the waste water and perform the purification process therein; a cover (3) which covers all of the components; half discs (8) with horizontal connection points and half discs (9) with diagonal connection points whose whole surface area shall be used for the purification process as the biofilm layer shall be located on said discs whereon the biological purification procedure shall be carried out; a drum (4) having conical points that act as water jets and which carry the half discs (8) with horizontal connection points and half discs (9) with diagonal connection points; and a motor (13) which ensures the rotation of the drum (4). While the motor (13) rotates the drum (4), all of the half discs (8) with horizontal connection points and half discs (9) with diagonal connection points are also rotated. By this means the bacteria which purifies the waste water and decomposes via oxygen, are continuously in contact with the waste water and air which are nutrition for said bacteria.

As the module is designed as a panel having screws and as the body (2), cover (3) and drum (4) have been produced from fibreglass reinforced polyester material; the product can be produced in parts as panels and it can be quickly mounted and dismounted. As a result as it has the advantage to be delivered at a dismounted state, 10 times more products can be delivered in average per unit carrier in comparison to its mounted state. At the same time as the panel weights with screws are such that they can be lifted and carried by two people, a crane or a heavy duty vehicle is not required for handling and it has the advantage of being easily mounted and used at its delivery point. This leads to the advantage that the product can be delivered to many destinations around the world with cost effective delivery and can be carried by man power in locations where cranes or heavy duty vehicles cannot be used. At the same time, the product is produced as a lightweight product as it is manufactured from composite, fibreglass reinforced polyester material and said product can be operated by solar power produced by solar panels, without the need for an energy source from the mains power.

In order for the bacteria to spend half their time during activation inside the waste water and the remaining other half outside of the water; the body (2) carrying the drum (4), has been filled with waste water at a close distance to the axis of the shaft (7) which is connected to the motor (13) which enables the rotation of the drum. During each cycle the whole drum (4) and as a result the horizontally connected half discs (8) and the diagonally connected half discs (9) shall be completely submerged into the water once. At the same time, the waste water and air move towards the centre of the drum by the water jet effect as water is received inside the drum (4) by means of the conical holes opened on the connection points of the drum (4); and the slurry layer that can accumulate at the centre of the drum (4) is removed; and the access of air is provided efficiently at the centre section of the drum (4) and as a result a healthy bacteria layer at a desired amount is established in the centre section. The speed of the motor (13) and reductor can be adjusted depending on the purification efficiency and amounts of the bacteria located on the discs.

The half discs (8) with horizontal connection points and half discs (9) with diagonal connection points merge with their own pairs and form the full disc (10) with diagonal connection points and the full disc (11) with horizontal connection points. The half pieces which form each disc, are produced from polyethylene (PE) or a similar material and as a result the production of discs which are durable against low/high pH environments have been provided. Each of the discs have been shaped and their surface areas have been increased in order to be used during the separation process with bacteria as a large surface area is crucial during said separation process. In order to reach this aim, heat has been applied inside the thermoform machine to the PE plate and said plate has been shaped under vacuum within aluminium moulds. At least a 14% increase in the surface area has been provided by means of the shape given. Moreover, besides the bacteria loading capacity obtained by increasing the surface area, the strengths of the discs have also been improved.

The horizontal half disks (8) and the diagonal half disks (9) can be produced in various sizes and thicknesses depending on the dimensions of the body (2). Moreover in order to decrease the weights of the parts and to be able to remove the slurry which could accumulate due to water and air circulation within the centre of the drum (4) and to ensure easy replacement, each disc has actually been formed as two semi-circle discs.

In order to retain the advantage of the large surface area obtained by forming the discs, the loss of area (bridging) is prevented as a result of the overlapping of the diagonal full discs (10) and horizontal full discs (11) which have been sequentially aligned on the drum (4). In order to reach this aim, the advantage of the preformation of the sequential alignment of the diagonal full disc (10) and the horizontal full disc (11) one after the other, has been used. The pattern difference obtained by means of the difference of the horizontal or diagonal positions relative to the floor of the conical protrusions (15) which pass through the tie rod (6) on each part, shall prevent the two parts from fitting into each other and the loss of surface area.

The number of the conic protrusions (15) on each disc (10 and 11) with diagonal and horizontal connection points on each half discs (8) with horizontal connection points and half discs (9) with diagonal connection points is thirteen.

The 6 tie rods (6) on a drum (4) enable the coupling of all these parts. The front/rear panel (23) located at both sides of the drum (4) provide the planes whereon the tie rods (6) are mounted and which limit movements. Each drum front/rear panel (23) are spaced apart from each other at a distance of the drum separator (22). The weight of the drum (4) constantly increases due to the bacteria mass carried on the discs besides the weight of the front/rear panel (23) of the drum, the tie rods (6) and the discs. In order for said weight of all these components not to be carried by the composite body (2), the weight is transferred to the legs (5) by means of the shaft (7). After the live bacteria layer on the discs complete their mission and they die, an important aspect of the invention in terms of usage is that the discs need to be cleaned and a new biofilm layer needs to be established. In order to reach this aim, the 3 channels which pass through the centre of the discs shall be used to remove and eliminate the dead biofilm layer. At the same time, by means of the space left between the discs formed of two pieces, the slurry is rapidly removed before it accumulates via the air and waste water circulation.

The waste water inlet (14) located on the body (2), enables the intake of waste water and following the purification of the water biologically, the clean water is discharged out of the body via the clean water outlet (12) located again on the body (2). The inlet and outlet points on the body (2) have been positioned diagonally such that they are at the furthest distance from each other. Therefore by using the advantage of the hypotenuse length between the inlet and outlet points, it has been aimed for the waste water to be stored within the module for a longer period of time, and for the efficiency of the purification to be increased by extending the biological purification processing time.

The body comprises two body front/rear panels (17), two body side panels (18) and a body base (19) which have been produced from at least 5 layered fibre materials having an angular form and an embossed surface in order to carry the pressure and the weight of the water imposed on the body (2). All of these parts are coupled together by means of screws and a hydrophobic seal is used at the connection points of both parts. By this means, although the body (2) has been formed by means of panels it has been ensured that it does not swell under water pressure and cause leakages, and the strength of the body (2) has been increased and the screws have been provided protection against the corrosive effect of water.

As it has been mentioned above, the external legs (5) carry the drum (4) directly by means of the shaft (7) in order to ensure that the weight of the drum (4) is not imposed on the composite body (2). Two fibreglass legs (16) are located at the section of the body (2) which is in contact with the floor. These fibreglass legs (16) both carry the weight of the body and also provide the storage and removal of the biofilm slurry that has died inside the inner volume that has been created by the legs.

The cover (3) has also been produced from fibreglass material similar to the body (2) and it accommodates the holes which allow the inlet and outlet of air. Nonetheless in order to also improve the delivery and storage processes of the cover (3); the cover (3) has been produced modularly, having two cover side panels (20) and two cover logo panels (21). The cover logo panel (21) can comprise the logo of the producer, the instruction manuals for the user, and various advertisements and said panel is a part that can be replaced if desired due to the modular structure of the cover (3).

As the invention whose aspects have been described above, rotates the discs using a low speed motor (13) for the ventilation of especially bacteria both the noise level has been reduced and the energy consumption value has been decreased.

1. A biological waste water purification module comprising:
a body which receives waste water and wherein the purification process is carried out;
a cover which covers all of the components;
horizontal half discs and diagonal half discs where biological materials shall be located on and whose whole surface is used for the purification process;
a drum which carries the horizontal half discs and the diagonal half disks;
a motor which enables rotation of the drum;
in order to improve values such as noise and energy consumption besides increasing the efficiency of the purification module used during the purification process of waste water;
a body filled with waste water at a close distance to an axis of the shaft connected to the motor which enables rotation and carries the drum in order to ensure that bacteria spend half their time during activation inside the waste water and the remaining other half outside of the water,
horizontal half disks and diagonal half discs produced from PE panels in order to increase their surface areas, which have been formed under vacuum inside aluminium moulds by heat application within a thermoform machine;
conical protrusions passing through tie rods positioned horizontally and diagonally in relation to the ground in order to prevent loss of surface area as a result of an overlapping of the diagonal full discs and horizontal full discs which shall be aligned sequentially with each other on the drum.

2. A biological waste water purification module according to claim 1 further comprising:
two body front/rear panels forming the body when coupled with screws, two body side panels and a body base; and
two cover side panels forming the cover section when coupled with the screws, and two cover logo panels,
in order to improve manufacturing, storage and delivery processes of the purification module used during the purification of waste water.

3. A biological waste water purification module according to claim 1, further comprising:
tie rods which couple with the drum and carry the half discs with horizontal connection points and the half discs with diagonal connection points.

4. A biological waste water purification module according to claim 1 further comprising:
3 channels that pass through the centre of the discs that are used to establish a new biofilm layer by removing the previous biofilm layer and replacing it with the new biofilm layer after cleansing the discs from the bacteria.

5. A biological waste water purification module according to claim 1 further comprising:
a waste water inlet located on the body, which enables the intake of waste water and a clean water outlet located again on the body which discharges the clean water following the biological purification of the water.

6. A biological waste water purification module according to claim 1 further comprising:
a leg that carries the drum directly via the shaft so that the weight of the drum is not carried by the body.
